(19) United States
(12) Patent Application Publication
(10) Pub. No.: US 2009/0017352 A1
(43) Pub. Date: Jan. 15, 2009

(54) FUEL CELL SYSTEM

(75) Inventor: Arato Takahashi, Shizuoka (JP)

Correspondence Address: YAMAHA HATSUDOKI KABUSHIKI KAISHA;C/O KEATING & BENNETT, LLP, 1800 Alexander Bell Drive, SUITE 200, Reston, VA, 20191, US

(73) Assignee: YAMAHA HATSUDOKI KABUSHIKI KAISHA, Iwata-shi (JP)

(21) Appl. No.: 12/169,730

(22) Filed: Jul. 9, 2008

(30) Foreign Application Priority Data
Jul. 11, 2007 (JP) 2007-182022

(51) Int. Cl. H01M 8/04

(52) U.S. Cl. 429/26

(57) ABSTRACT

A fuel cell system easily and reliably prevents the system's surroundings from becoming wet. The fuel cell system includes a casing which accommodates a cell stack; pipes arranged to guide exhaust containing water and water vapor from a cathode outlet in the cell stack to an outside; and a holder unit attached to the casing. The holder unit includes a housing member and an absorption member housed in the housing member. The exhaust gas which contains water and water vapor from the cathode outlet in the cell stack flows through the pipes, and is discharged from another pipe, and is blown to the absorption member housed in the housing member, and the water contained in the exhaust gas is absorbed by the absorption member.

### BACKGROUND OF THE INVENTION

1. Field of the Invention

The present invention relates to a fuel cell system, and more specifically to a fuel cell system including a fuel cell which produces exhaust gas that contains water and water vapor.

2. Description of the Related Art

It is public knowledge that in a fuel cell system, fuel is supplied to an anode in a fuel cell while air which contains oxygen is supplied to a cathode in the fuel cell, thereby causing the fuel cell to generate electric power. Exhaust gas from the cathode contains moisture (including water and water vapor) which is produced as a result of power generation, etc.

For example, JP-A 2006-107786 discloses a fuel cell system, in which exhaust gas from the cathode is cooled by a radiator to turn the water vapor contained in the exhaust gas into water. Then, the water contained in the exhaust gas is collected in a tank, and the water in the tank is utilized for aqueous fuel solution. The exhaust gas, which contains unliquefied water vapor, is discharged from a discharge pipe.

The temperature of the radiator can become higher than the ambient temperature. As a result, in the fuel cell system according to JP-A 2006-107786, there is a case where water vapor is allowed to pass through the radiator, then liquefied on the downstream side of the radiator, and discharged from the discharge pipe. If electronic components are disposed near the fuel cell system or if there is no drainage system at the place where the fuel cell system is disposed, it is not desirable to allow water to wet the surroundings of the fuel cell system.

With the use of the radiator, it is possible to liquefy most of the water vapor contained in the exhaust gas by cooling the exhaust gas to a level of the ambient temperature. Then, by collecting the water contained in the exhaust gas on the downstream side of the radiator, it is possible to reduce the amount of water discharged from the discharge pipe. However, in order to achieve this, a powerful radiator is required, and a large amount of electric power must be consumed to drive a cooling fan to cool the radiator.

### SUMMARY OF THE INVENTION

In order to overcome the problems described above, preferred embodiments of the present invention provide a fuel cell system that is capable of easily and reliably preventing the system's surroundings from becoming wet.

According to a preferred embodiment of the present invention, a fuel cell system includes a fuel cell having a cathode; a discharge pipe connected with the cathode to guide exhaust gas, which contains water and water vapor, from the cathode to an outside; and a water holding unit arranged to hold the water after the water has been discharged from the discharge pipe.

In a preferred embodiment of the present invention, water which is contained in the exhaust gas discharged from the discharge pipe is held by the water holding unit. With this arrangement, the fuel cell system's surroundings are easily and reliably prevented from becoming wet.

Preferably, the water holding unit includes an absorption member which absorbs water. In this case, the absorption member in the water holding unit absorbs and holds the water. With this arrangement, water becomes more apt to vaporize than in a case where the water is held in a container, for example, making possible to keep the water holding unit clean. This leads to a reduction in the burden of maintenance work including cleaning and replacing of the water holding unit.

Further preferably, the fuel cell system further includes a casing which accommodates the fuel cell, and the water holding unit is provided outside of the casing. By providing the water holding unit outside of the casing as described, the water held by the water holding unit becomes much more apt to be vaporized, making possible to keep the water holding unit clean, as well as making it easy to maintain the water holding unit.

Further, preferably, the fuel cell system further includes a collection unit arranged in the discharge pipe to collect water contained in the exhaust gas. In this case, the collection unit collects the water contained in the exhaust gas, making it possible to reduce the amount of water which is discharged from the discharge pipe and therefore, it becomes possible to more reliably prevent the surroundings of the fuel cell system from becoming wet.

Preferably, the fuel cell system further includes a liquefying unit provided between the cathode and the collection unit to liquefy the water vapor contained in the exhaust gas. In this case, the liquefying unit liquefies water vapor contained in the exhaust gas and thereafter, the collection unit collects the water contained in the exhaust gas. With this arrangement, it becomes possible to reduce the amount of water vapor which becomes liquid on the downstream side of the collection unit, and thus to further reduce the amount of water discharged from the discharge pipe.

Further preferably, the fuel cell system further includes a wind supplying unit arranged to supply wind to the absorption member. In this case, it is possible to vaporize a greater amount of water by supplying wind to the absorption member, and it becomes possible to dry the absorption member quickly.

Further, preferably, the wind supplying unit supplies the absorption member with the wind which has been supplied to an outer circumference of the discharge pipe. When warm exhaust gas which is discharged from the cathode flows through the discharge pipe, the discharge pipe is warmed. Therefore, the wind which passes around the circumference of the warm discharge pipe is also warmed, and by supplying this wind to the absorption member, a greater amount of water can be vaporized. As a result, even if the amount of water contained in the exhaust gas has increased, it is still possible to facilitate vaporization of the water held in the absorption member, and to prevent the water from being rotten in the absorption member.

Preferably, the wind supplying unit supplies the absorption member with the wind which has been supplied to an outer circumference of the liquefying unit. The liquefying unit is warmed when it absorbs heat from the water vapor in the liquefying process of the water vapor. Therefore, by supplying this wind which is warmed by passing around the circumference of the warm liquefying unit to the absorption member, a greater amount of water can be vaporized, and it becomes possible to prevent the water from being rotten in the absorption member.

Further preferably, the fuel cell further includes an anode, the fuel cell system further includes a cooling unit arranged to cool the aqueous fuel solution from the anode, and the wind supplying unit supplies the absorption member with the wind which has been supplied to an outer circumference of the cooling unit. The cooling unit is warmed by heat absorbed from the aqueous fuel solution in the cooling process of the aqueous fuel solution. Therefore, by supplying this wind which is warmed by passing around the circumference of the warm cooling unit to the absorption member, a greater amount of water can be vaporized, and it becomes possible to prevent the water from being rotten in the absorption member.

Further, preferably, the fuel cell system further includes a coolant pipe for a coolant to flow after passing the fuel cell, and the wind supplying unit supplies the absorption member with the wind which has been supplied to an outer circumference of the coolant pipe. When cooling the fuel cell, the coolant is warmed by heat which it absorbs from the fuel cell, and then the coolant flows into the coolant pipe. Therefore, by supplying this warm wind, which is warmed by passing around the circumference of the warm coolant pipe in which warm coolant is flowing, to the absorption member, a greater amount of water can be vaporized, and it becomes possible to prevent the water from being rotten in the absorption member.

The above-described and other features, elements, characteristics, aspects and advantages of the present invention will become more apparent from the following detailed description of preferred embodiments of the present invention with reference to the attached drawings.

### BRIEF DESCRIPTION OF THE DRAWINGS

FIG. 1 is a perspective view of a fuel cell system according to a preferred embodiment of the present invention, taken from a front above right viewing point.

FIG. 2 is a perspective view of the fuel cell system according to a preferred embodiment of the present invention, taken from a rear above right viewing point.

FIG. 3 is a schematic diagram showing constituent elements in a casing of the fuel cell system according to a preferred embodiment of the present invention.

FIG. 4 is a partial perspective view of the casing, without a holder unit.

FIG. 5 is a perspective view of the holder unit, taken from a front above right viewing point.

FIG. 6 is a sectional view taken along lines Z-Z in FIG. 2.

FIG. 7 is a diagram showing a section taken along lines X1-X1 in FIG. 6.

FIG. 8 is a diagram showing a section taken along lines X2-X2 in FIG. 6.

FIG. 9 is a sectional view taken along lines Z-Z in FIG. 2, with the holder unit replaced by one of a different design.

FIG. 10 is a diagram showing a section taken along lines X3-X3 FIG. 9.

FIG. 11 is a diagram showing constituent elements in a casing of a fuel cell system according to another preferred embodiment of the present invention.

### DETAILED DESCRIPTION OF THE PREFERRED EMBODIMENTS

Hereinafter, preferred embodiments of the present invention will be described with reference to the drawings.

A fuel cell system 10 preferably is a direct methanol fuel cell system which uses methanol (aqueous methanol solution) directly, i.e., without refining, for production of electric energy (power generation). The fuel cell system 10 is a portable system, and may be used, for example, in an outdoor concert to supply electric power to electronic equipment such as an acoustic instrument. The fuel cell system 10 preferably weighs approximately 30 kg, and the fuel cell system 10 can generate a maximum power of approximately 500 W, for example.

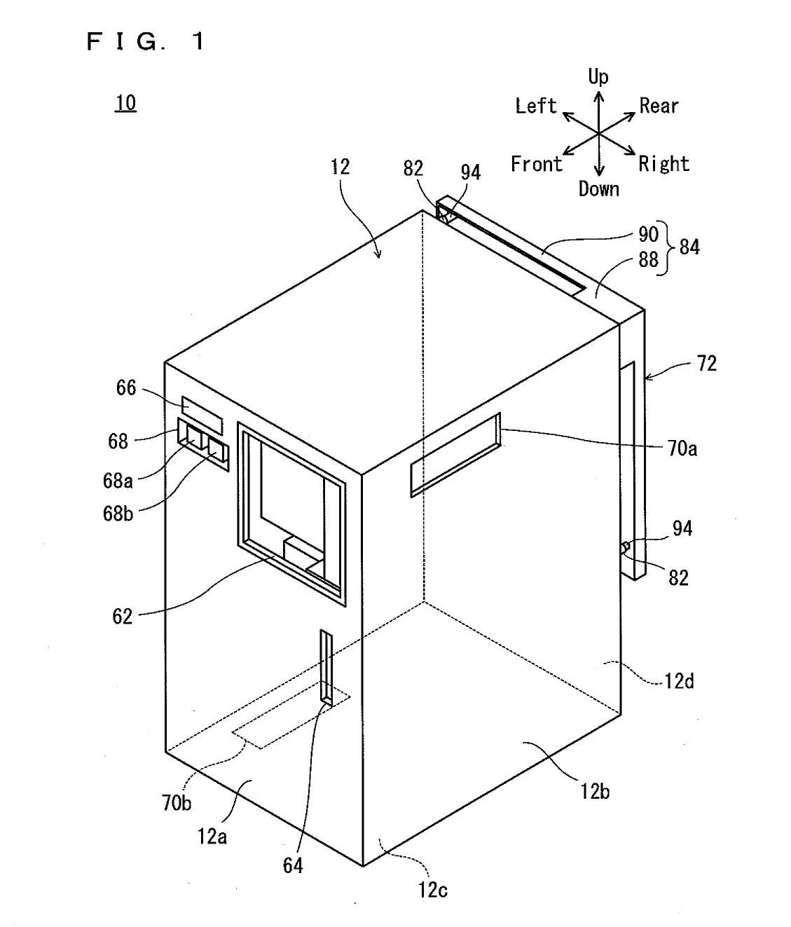

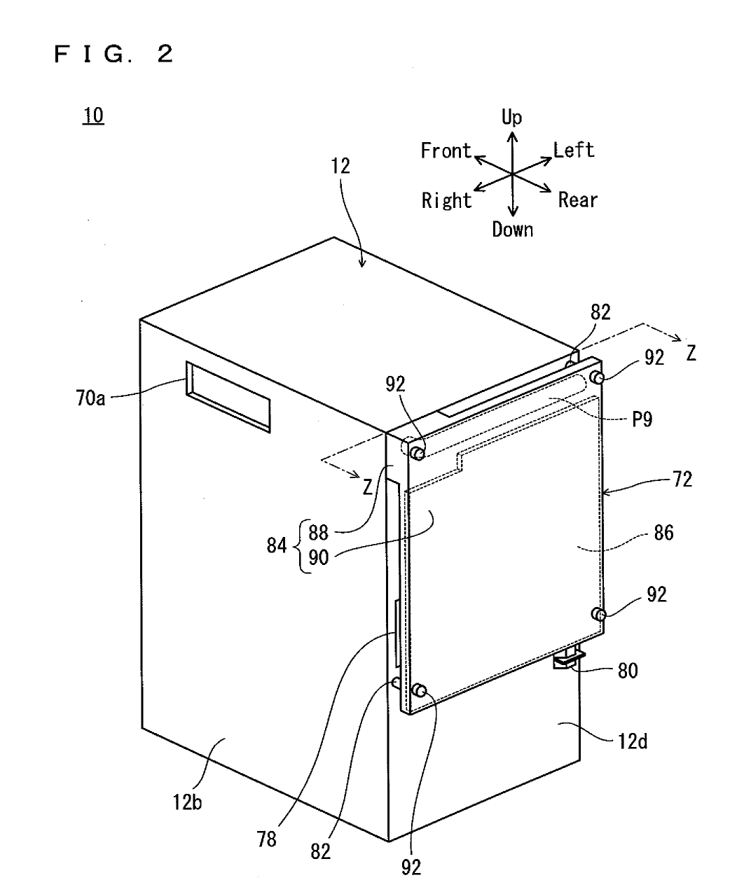

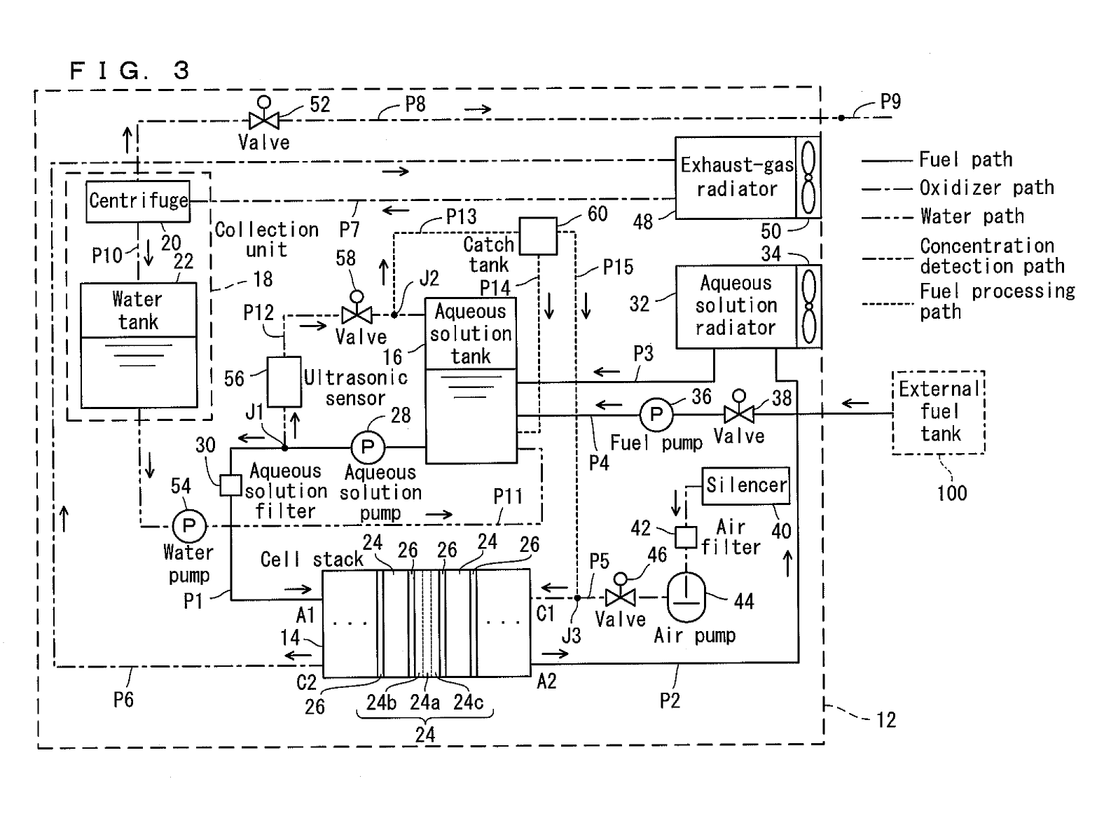

FIG. 1 is a perspective view of the fuel cell system 10 taken from a front above right viewing point. FIG. 2 is a perspective view when the fuel cell system 10 is viewed from a rear above right viewing point. As shown in FIG. 1 and FIG. 2, the fuel cell system 10 includes a casing 12 which is preferably a substantially parallelepiped shaped box. FIG. 3 is a schematic diagram showing constituent elements inside the casing 12 of the fuel cell system 10.

As shown in FIG. 3, the casing 12 houses a fuel cell stack (hereinafter simply called cell stack) 14, an aqueous solution tank 16 and a collection unit 18. The collection unit 18 includes a centrifuge 20 and a water tank 22.

The cell stack 14 preferably includes a plurality of fuel cells 24 piled or stacked with separators 26 sandwiched in between. Each of the fuel cells 24 in the cell stack 14 is capable of generating electric power based on electrochemical reactions between hydrogen ions derived from methanol and oxygen (oxidizer), and includes an electrolyte film 24a provided by a solid polymer film, for example, as well as an anode (fuel electrode) 24b and a cathode (air electrode) 24c which are opposed to each other to sandwich the electrolyte film 24a. Each of the anode 24b and the cathode 24c includes a platinum catalyst layer provided on a side facing the electrolyte film 24a.

The aqueous solution tank 16 holds aqueous methanol solution of a concentration (containing methanol in an amount of approximately 3 wt. %, for example) suitable for the electrochemical reactions at the cell stack 14. The aqueous solution tank 16 is connected with an anode inlet A1 of the cell stack 14 via a pipe P1. An aqueous solution pump 28 and an aqueous solution filter 30 are connected with the pipe P1 in this order, from the side closer to the aqueous solution tank 16. When the aqueous solution pump 28 is driven, aqueous methanol solution in the aqueous solution tank 16 is supplied to the cell stack 14.

The cell stack 14 has an anode outlet A2, to which the aqueous solution tank 16 is connected via a pipe P2, an aqueous solution radiator 32 and a pipe P3. The aqueous solution radiator 32 is provided with a fan 34 which supplies wind to the aqueous solution radiator 32 in order to cool the aqueous solution radiator 32.

The aqueous solution tank 16 is connectable with an external fuel tank 100 via a pipe P4. The pipe P4 is connected with a fuel pump 36 and a valve 38 in this order, from the side closer to the aqueous solution tank 16. The external fuel tank 100 holds methanol fuel of a high concentration, which contains methanol at a rate of approximately 50 wt. %, for example, as the fuel for the electrochemical reactions at the cell stack 14. Connection of the external fuel tank 100 with the pipe 4 is made appropriately by a human operator, for example. With the external fuel tank 100 connected with the pipe P4, the valve 38 opened, and the fuel pump 36 being driven, methanol fuel in the external fuel tank 100 is supplied to the aqueous solution tank 16.

The pipes P1 through P4 serve primarily as a fuel path.

The cell stack 14 has a cathode inlet C1, to which a silencer 40 is connected via a pipe P5. The pipe P5 is connected with an air filter 42, an air pump 44 and a valve 46 in this order, from the side closer to the silencer 40. When the air pump 44 is driven, outside air which contains oxygen is supplied to the cell stack 14.

The cell stack 14 has a cathode outlet C2, to which an exhaust-gas radiator 48 is connected via a pipe P6. The exhaust-gas radiator 48 is provided with a fan 50 which supplies wind to the exhaust-gas radiator 48 in order to cool the exhaust-gas radiator 48. The exhaust-gas radiator 48 is connected with a centrifuge 20 of the collection unit 18 via a pipe P7.

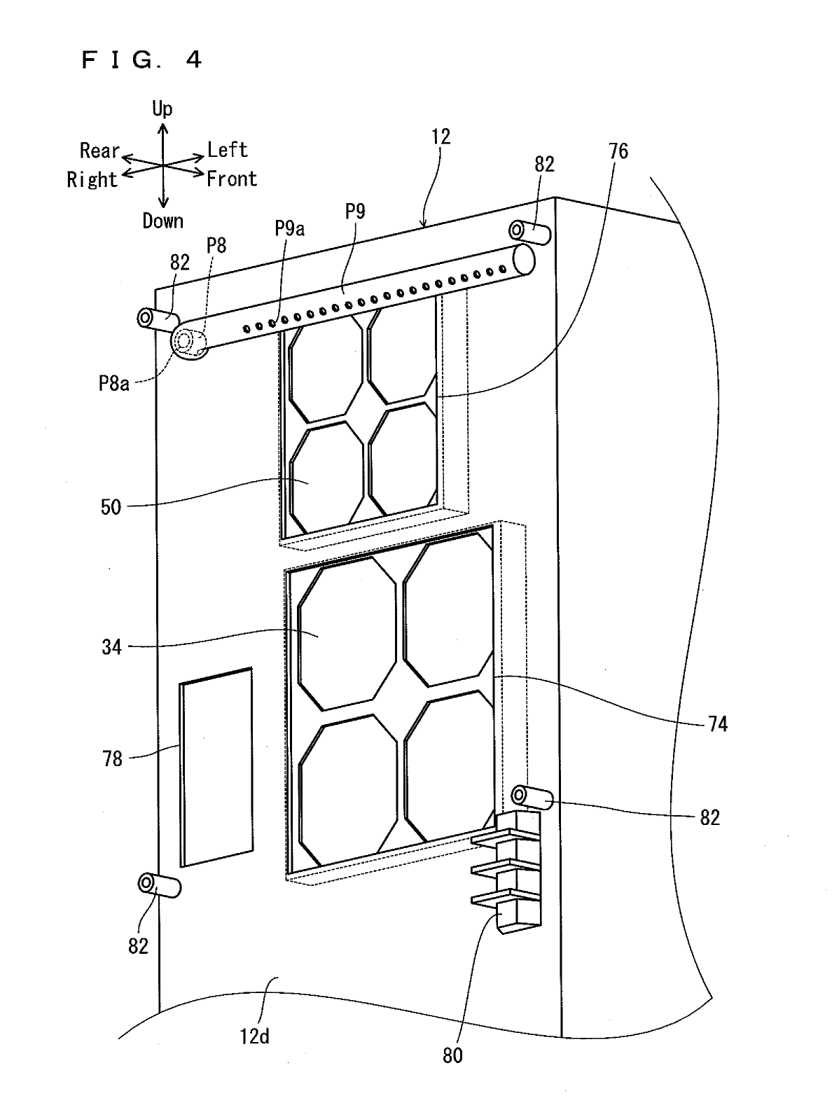

The centrifuge 20 separates water from exhaust gas which comes from the exhaust-gas radiator 48 by applying a centrifugal force to the exhaust gas. The centrifuge 20 is connected with a pipe P8 which is connected with a valve 52. The pipe P8 extends from the casing 12, and where it extends, there is connected a pipe P9 which has a plurality of discharge ports P9a (see FIG. 4).

The pipes P5 through P9 described above serve primarily as a path for the oxidizer.

The centrifuge 20 and the water tank 22 in the collection unit 18 are connected with each other via a pipe P10. The water tank 22 holds water which is to be supplied to the aqueous solution tank 16. The water tank 22 is supplied with water which is separated from exhaust gas by the centrifuge 20.

The water tank 22 is connected with the aqueous solution tank 16 via a pipe P11. The pipe P11 is connected with a water pump 54. When the water pump 54 is driven, water in the water tank 22 is supplied to the aqueous solution tank 16.

The pipes P10, P11 serve as a water path.

In the pipe P1, there is a junction J1 where the aqueous solution pump 28 is connected with the aqueous solution filter 30, and to this junction J1, an end of a pipe P12 is connected in order to introduce a portion of aqueous methanol solution from the pipe P1. The pipe P12 is connected with an ultrasonic sensor 56 and a valve 58. The pipe P12 has another end which is connected with the aqueous solution tank 16.

The ultrasonic sensor 56 is used to detect the concentration of aqueous methanol solution in the pipe P12, based on a nature of the ultrasonic waves that the ultrasonic propagation speed in aqueous methanol solution changes depending on the concentration of the solution. When detecting the concentration, the valve 58 is closed and the flow of aqueous methanol solution in the pipe P12 is stopped. After the concentration detection, the valve 58 is opened and the aqueous methanol solution whose concentration has been detected is returned to the aqueous solution tank 16.

The pipe P12 described above serves primarily as a concentration detection path.

The aqueous solution tank 16 is connected with a catch tank 60 via pipes P13 and P14. The pipe P13 is connected with a junction J2 which is on the downstream side of the valve 58 in the pipe P12. The catch tank 60 is connected with a pipe P15. The pipe P15 is connected with a junction J3 which is on the downstream side of the valve 46 in the pipe P5.

The pipes P13 through P15 serve as a fuel processing path.

System components, such as the aqueous solution pump 28, the fuel pump 36, the air pump 44, the fans 34, 50 and the valves 38, 46, 52, 58, and soon are controlled by an unillustrated controller which is disposed inside the casing 12.

Returning to FIG. 1, the casing 12 has a front wall 12a which is provided with an air intake 62 arranged to introduce outside air into the casing 12; a check window 64 arranged to allow for checking the amount of water in the water tank 22; a display 66 arranged to display various kinds of information; and an input portion 68 used to issue an operation start command and an operation stop command.

The check window 64 is used in order to check (visually) an unillustrated water gauge provided in the water tank 22. The display 66 includes a liquid-crystal display, for example, etc., and displays information such as power generation status in the cell stack 14. The input portion 68 includes an operation start button 68a and an operation stop button 68b. The operation start button 68a and the operation stop button 68b do not protrude from the wall 12a. This arrangement prevents such a problematic situation that an accidental contact with an obstacle will cause the operation start button 68a or the operation stop button 68b to be pressed unexpectedly.

The casing 12 has a right side wall 12b provided with a recessed handle 70a at a location close to the wall's upper end. Likewise, the casing 12 has a bottom plate 12c provided with a recessed handle 70b at a location close to the wall's left end. Using the two handles 70a, 70b which are provided in the casing 12 as described, it is possible to tilt the casing 12 to the right side (toward the wall 12b) and hold it. This makes it easy to carry the fuel cell system 10.

As shown in FIG. 1 and FIG. 2, the casing 12 has a rear wall 12d, where a holder unit 72 which holds water extracted from the exhaust gas from the pipe 9, is attached in a detachable manner. Referring also to FIG. 4, from a location near an upper right corner of the wall 12d, the pipe P8 extends perpendicularly with respect to the wall 12d. To this extended end of the pipe P8, the pipe P9 is connected. It should be noted here that FIG. 4 is a partial perspective view of the casing 12 without the holder unit 72, taken from a rear lower left viewing point.

As shown in FIG. 4, the pipe P9 is formed as a tube having one end connected with the pipe P8 and the other end (the end on the downstream side) closed. From the end of the pipe P8, the pipe P9 bends to the left and extends horizontally, in parallel or substantially parallel to the wall 12d. The pipe P9 preferably has an inner diameter of approximately 11 mm, for example. With such a design, the pipe P9 has a side surface provided with a plurality (for example, twenty-one, according to the present preferred embodiment) of discharge ports P9a, opening rearward and downward, and from the right side to the left side. Each of the discharge ports P9a is circular, having an approximately 4 mm diameter, for example. Since the discharge ports P9a face rearward and downward, it is possible to discharge water which is contained in the exhaust gas efficiently so that the water will not wet the casing 12.

The wall 12d is also provided with a wind outlet 74 which exposes the fan 34 to the outside, and a wind outlet 76 which exposes the fan 50 to the outside. When the fan 34 turns its blades, outside air is introduced through the air intake 62 of the wall 12a. Thus, the outside air is supplied to the aqueous solution radiator 32 which is disposed more closely to the air intake 62 (upstream side of the air flow) than the fan 34. In other words, driving the fan 34 supplies wind to the aqueous solution radiator 32. The wind which was supplied to cool the aqueous solution radiator 32 is then discharged by the fan 34 via the wind outlet 74, to the outside of the casing 12. Likewise, when the fan 50 is driven, wind is supplied to the exhaust-gas radiator 48 (see FIG. 3). The wind which was supplied in order to cool the exhaust-gas radiator 48 is then discharged by the fan 50 via the wind outlet 76, to the outside of the casing 12.

The wall 12d is also provided with a drawer hole 78 and output terminals 80. The drawer hole 78 allows to draw the pipe P4 (see FIG. 3) out of the casing 12. By drawing the pipe P4 from the casing 12 via the drawer hole 78 and connecting it with the external fuel tank 100, it becomes possible to supply methanol fuel to the aqueous solution tank 16. The output terminals 80 are used to tap the electric power from the fuel cell system 10. By connecting the output terminals 80 with lead wires for example, it becomes possible to tap the power from the fuel cell system 10.

Further, the wall 12d is provided with fittings 82 for attaching the holder unit 72, at locations near upper right corner, near upper left corner, slightly lower than the center and near right edge, and slightly lower than the center and near left edge respectively. The fittings 82 are tubular, having an inner circumferential surface formed with a thread groove.

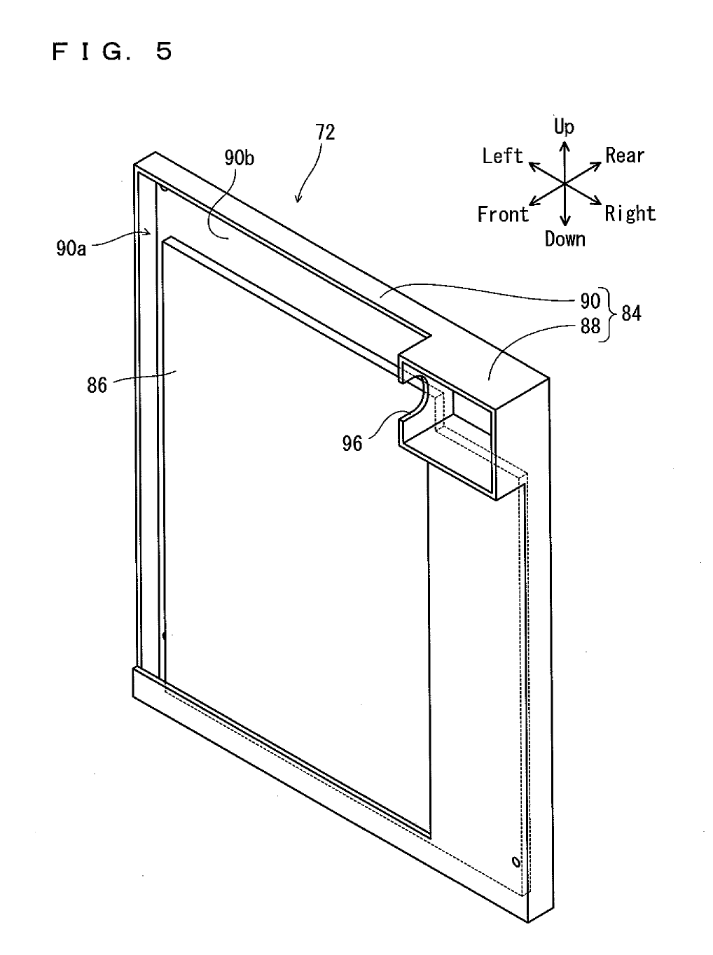

Next, the holder unit 72 will be described in detail with reference to FIG. 5 through FIG. 8.

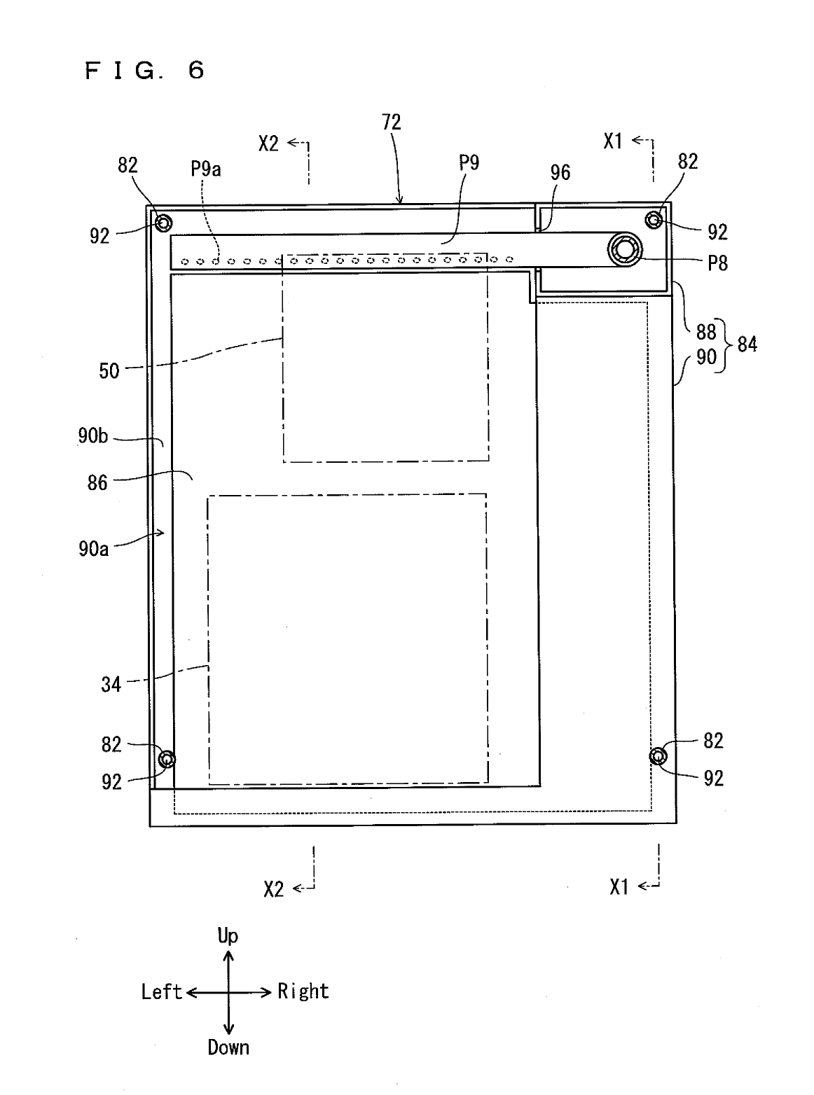

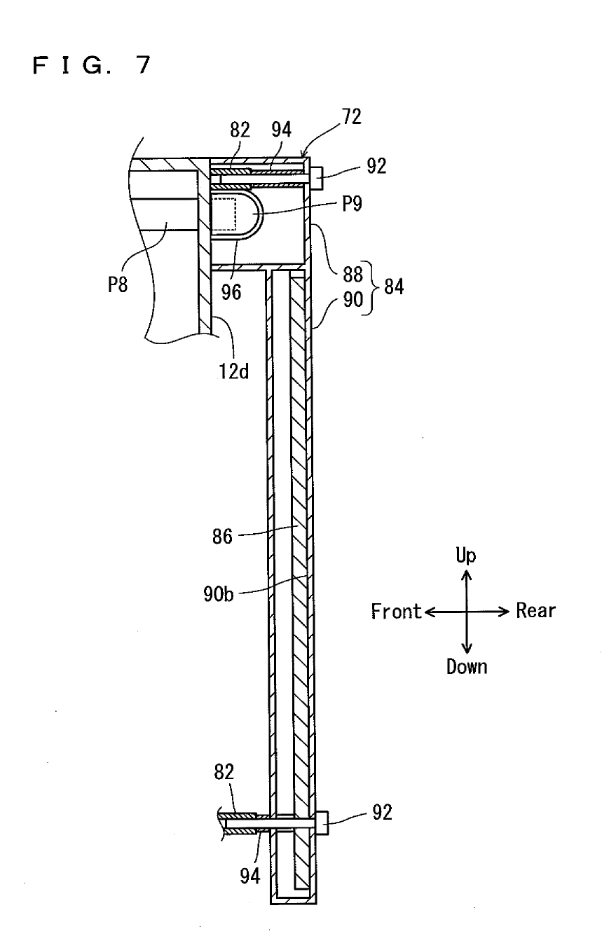

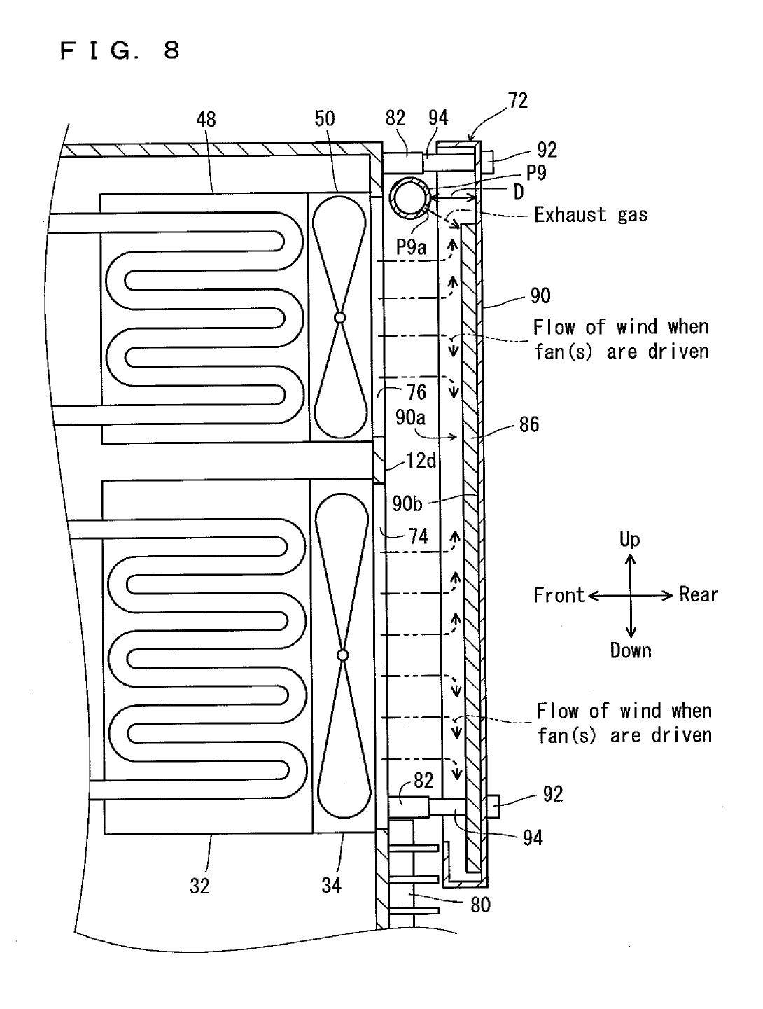

FIG. 5 is a perspective view of the holder unit 72 shown in FIG. 1, taken from a rear above right viewing point. FIG. 6 is a sectional view of a section taken by cutting the fuel cell system 10 shown in FIG. 2 with a plane where the casing 12 and the holder unit 72 contact with each other, and viewing the section from a direction indicated by Arrow Z. FIG. 7 is a diagram showing a section of the fuel cell system 10 taken along lines X1-X1 in FIG. 6. FIG. 8 is a diagram showing a section of the fuel cell system 10 taken along lines X2-X2 in FIG. 6. As shown in FIG. 5 and FIG. 6, the holder unit 72 includes a housing member 84 and an absorption member 86 accommodated in the housing member 84. The housing member 84 includes two portions which are formed integrally with each other, i.e., an enclosing portion 88 which encloses the right end portion of the pipe P9, and a housing portion 90 which accommodates the absorption member 86. The housing member 84 has through-holes, and is attached to the wall 12d by threading bolts 92 through these through-holes into respective fittings 82, covering a portion from the upper end to a slightly lower portion than the center, of the wall 12d (see FIG. 2). As shown in FIG. 7 and FIG. 8, collars 94 are inserted between the housing member 84 and the fittings 82 in order to position the housing member 84. The housing member 84 is made of a corrosion-resistant metal, for example. Specifically, the housing member 84 is made of a stainless steel such as JIS-SUS 304 and JIS-SUS 316, an aluminum alloy treated with a surface treatment such as an alumite process, for example, etc.

As shown in FIG. 5, FIG. 6 and FIG. 7, the enclosing portion 88 is preferably formed as a parallelepiped which is opened to the front. The enclosing portion 88 has a left side wall provided with a cutout 96 in order to allow the pipe P9 (see FIG. 6) to pass through from the right to the left.

As shown in FIG. 5, FIG. 6 and FIG. 8, the box-like housing portion 90 has its front wall largely cut out, whereby there is provided an opening 90a correspondingly to the discharge ports P9a which are formed from left to right, as well as to the fans 34, 50. Inside the housing portion 90 and in parallel or substantially parallel to the wall 12d and the pipe P9, there is provided a pasting surface 90b, to which a sheet-shaped absorption member 86 is pasted to cover approximately the entire surface of the pasting surface 90b below the pipe P9.

The absorption member 86 may include any material which is capable of absorbing and holding liquid. Examples include paper, cloth, sponge, porous ceramic, foam metal and polymer, and combinations of these. Specifically, the absorption member 86 is preferably provided by a polymer sheet manufactured by TOYO TOKUSHI, Ltd., or a Cosmo Water Absorption Sheet manufactured by TOYOBO Co., Ltd., for example.

As shown in dashed single-dotted lines in FIG. 8, exhaust gas from the discharge ports P9a blows an area of the absorption member 86 near its upper end, and the absorption member 86 absorbs and holds water which was contained in the exhaust gas. Also, as shown in dashed double-dotted lines in FIG. 8, driving of the fans 34, 50 supplies air to the absorption member 86 as the air is discharged via the wind outlets 74, 76 from the casing 12. In other words, driving the fans 34, 50 supply a wind to the absorption member 86.

When used to cool the aqueous solution radiator 32, the wind from the wind outlet 74 absorbs heat from the aqueous solution radiator 32, and becomes warm wind (not cooler than the ambient temperature). The same applies to the wind from the wind outlet 76 which has been used for cooling the exhaust-gas radiator 48. Therefore, the absorption member 86 is supplied with warm wind.

A distance D from the pipe P9 to the pasting surface 90b is set to an appropriate value so as to ensure that the absorption member 86 pasted onto the pasting surface 90b can receive the exhaust gas from the discharge ports P9a and that the exhaust gas from which the absorption member 86 has absorbed the water is released smoothly to the outside. Specifically, if the air pump 44 has an output of 100 L/m (liter per minute) in a normal operation, the distance D from the pipe P9 to the pasting surface 90b is set to approximately 30 mm, for example.

In the present preferred embodiment, the holder unit 72 which includes the housing member 84 and the absorption member 86 defines the holding unit. The collection unit 18 which includes the centrifuge 20 and the water tank 22 defines the collection unit. The fans 34 and 50 each define the wind supplying unit. The liquefying unit includes the exhaust-gas radiator 48, the cooling unit includes the aqueous solution radiator 32, and the discharge pipe includes the pipes P6 through P9.

Next, a basic operation of the fuel cell system 10 will be described.

When the operation start button 68a is pressed, the fuel cell system 10 starts the controller and starts the system operation, whereby it becomes possible to supply electric power to external electronic equipment from an unillustrated secondary battery in the casing 12. Then, when the charge in the secondary battery comes down below a predetermined charge rate, the valves 46, 52 are opened, and power from the secondary battery is used to drive the aqueous solution pump 28 and the air pump 44, to cause the cell stack 14 to start power generation.

Referring to FIG. 3, as the aqueous solution pump 28 is driven, aqueous methanol solution in the aqueous solution tank 16 flows into the pipe P1 then, flows through the aqueous solution pump 28, the aqueous solution filter 30 and the anode inlet A1, and is supplied to the anode 24b directly, in each of the fuel cells 24 included in the cell stack 14.

On the other hand, as the air pump 44 is driven, external air is introduced from the air intake 62 (see FIG. 1) into the casing 12, and then into the silencer 40. The air which entered the silencer 40 then flows into the pipe P5, the air filter 42, the air pump 44, the valve 46 and the cathode inlet C1, and is supplied to the cathode 24c in each of the fuel cells 24 included in the cell stack 14.

With the valve 58 closed, water vapor, gaseous methanol and carbon dioxide, etc. in the aqueous solution tank 16 flow into the pipe P12, the junction J2 and the pipe P13, and enter the catch tank 60. In the catch tank 60, water vapor and gaseous methanol are cooled. Then, aqueous methanol solution obtained in the catch tank 60 is returned to the aqueous solution tank 16 via the pipe P14. Unliquefied water vapor and methanol, as well as carbon dioxide, etc. flow from the catch tank 60 to the pipe P15, then the junction J3 and the pipe P5, and enters the cathode inlet C1.

At the anode 24b in each fuel cell 24, methanol in the supplied aqueous methanol solution chemically reacts with water, and produces carbon dioxide and hydrogen ions. The hydrogen ions flows through the electrolyte film 24a to the cathode 24c, where the hydrogen ions electrochemically react with oxygen (oxidizer) which is contained in the air supplied to the cathode 24c, producing moisture (water and water vapor) and electric energy. In other words, power generation takes place in each of the fuel cells 24, i.e., in the cell stack 14. The temperature of the cell stack 14 is increased by heat from various reactions, and as the temperature increases, the output from the cell stack 14 increases. The fuel cell system 10 transfers to a normal operation where steady power generation is possible, when the cell stack 14 has attained a temperature of approximately 60° C., for example. Power from the cell stack 14 is utilized to charge the secondary battery, to drive external electronic equipment, etc.

Now, aqueous methanol solution which contains carbon dioxide produced at the anode 24b in each of the fuel cells 24 as well as unused methanol is heated in the electrochemical reactions. The carbon dioxide and the aqueous methanol solution flow through the anode outlet A2 of the cell stack 14 and the pipe P2, and enter the aqueous solution radiator 32. The aqueous solution radiator 32, which is cooled by the wind as the fan 34 is driven, cools the aqueous methanol solution which is flowing inside. The wind which has cooled the aqueous solution radiator 32 becomes warm by absorbing heat released from the aqueous solution radiator 32. Then, the warm wind is supplied to the absorption member 86 via the fan 34 and the wind outlet 74 (see FIG. 8). The warm wind, which is supplied to the absorption member 86 as the fan 34 is driven, flows on the surface of the absorption member 86, and then out of the system, from between the wall 12d and the housing member 84. During normal operation, the fan 34 is driven continuously and the cooling of aqueous methanol solution by the aqueous solution radiator 32 is continued. Aqueous methanol solution from the aqueous solution radiator 32 is returned to the aqueous solution tank 16 via the pipe P3. In other words, by driving the aqueous solution pump 28, aqueous methanol solution in the aqueous solution tank 16 is circularly supplied to the cell stack 14.

In the cathode 24c of each fuel cell 24, evaporated methanol from the catch tank 60 and methanol which has moved to the cathode 24c by a cross-over phenomenon make chemical reactions with oxygen, and decompose into non-harmful moisture and carbon dioxide in the platinum catalyst layer.

The cathode outlet C2 of the cell stack 14 discharges exhaust gas which contains moisture produced at each cathode 24c, moisture which has transferred to each cathode 24c by cross-over phenomenon, carbon dioxide produced at each cathode 24c, unused air, etc. Most of water vapor contained in the exhaust gas is discharged in the form of water (liquid) from the cathode outlet C2, but saturated water vapor components are discharged in the form of gas.

The exhaust gas from the cathode outlet C2 flows through the pipe P6 into the exhaust-gas radiator 48. The exhaust-gas radiator 48, which is cooled by the wind generated by the fan 50, cools the exhaust gas that flows inside. This process liquefies water vapor contained in the exhaust gas. Such a liquefying operation as described is controlled by the controller which makes adjustment on the amount of wind (the output of the fan 50) supplied to the exhaust-gas radiator 48 by the fan 50. The control is based on results of detection from an unillustrated water amount sensor which is provided in the water tank 22. Specifically, when the amount of water in the water tank 22 becomes small, the controller increases the output of the fan 50 to increase the amount of water contained in the exhaust gas. On the other hand, when the amount of water in the water tank 22 is large, the controller decreases the output of the fan 50 so that the amount of water contained in the exhaust gas will not increase. The wind which has cooled the exhaust-gas radiator 48 is heated by the heat released from the exhaust-gas radiator 48 and becomes warm. Then, this warm wind is supplied, via the fan 50 and the air outlet 76, to the absorption member 86 (see FIG. 8). The warm wind, which is sent to the absorption member 86 as the fan 50 is driven, flows on the surface of the absorption member 86, and then out of the system, from between the wall 12d and the housing member 84.

Exhaust gas from the exhaust-gas radiator 48 is supplied to the centrifuge 20 via the pipe P7. At the centrifuge 20, water is separated from the exhaust gas, and the water is supplied to the water tank 22 via the pipe P10. In other words, water separated from the exhaust gas by the centrifuge 20 is collected (recovered) in the water tank 22. Water in the water tank 22 is supplied to the aqueous solution tank 16 appropriately as the water pump 54 is driven.

On the other hand, after water has been separated in the centrifuge 20, the exhaust gas flows into the pipe P8 and is discharged, via the valve 52, from the discharge ports P9a of the pipe P9. Even after the centrifuge 20 has separated water, certain amount of water vapor remains in the exhaust gas, and there is a case where a portion of the water vapor is liquefied when it is cooled in the pipes P8, P9, approximately to the ambient temperature. In this case, exhaust gas discharged from the discharge ports P9a of the pipe P9 contains water, water vapor, carbon dioxide, unused air, etc.

Referring to FIG. 8, exhaust gas from the discharge ports P9a blows an area of the absorption member 86 near its upper end. In this process, water contained in the exhaust gas is absorbed by the absorption member 86. Thereafter, exhaust gas which does not contain water (liquid) flows out of the system from between the wall 12d and the housing member 84.

According to the fuel cell system 10 as described, water which is contained in the exhaust gas discharged from the discharge ports P9a of the pipe P9 is absorbed by the absorption member 86, easily and reliably preventing the system's surroundings from becoming wet.

Since the housing member 84 is arranged to ensure that the pasting surface 90b of the housing portion 90 will receive the exhaust gas discharged from the discharge ports P9a of the pipe P9, it is possible and simple to make sure that water contained in the exhaust gas is absorbed by the absorption member 86.

By providing the absorption member 86 to absorb and hold the water, the water becomes more apt to vaporize, making possible to keep the absorption member 86 and the housing member 84 clean, which leads to reduced burden on maintenance work including cleaning and replacing of the holder unit 72.

By providing the holder unit 72 outside of the casing 12, it becomes possible to make the holder unit 72 more apt to dry, making possible to keep the holder unit 72 clean, as well as making it easy to maintain the holder unit 72.

By collecting water in the water tank 22 after the water is separated from the exhaust gas by the centrifuge 20, it becomes possible to reduce the amount of water which will reach the pipes P8, P9, and to reduce the amount of water discharged from the discharge ports P9a and therefore, it becomes possible to more reliably prevent the surroundings of the fuel cell system 10 from becoming wet.

The system is capable of liquefying water vapor which is contained in the exhaust gas with the exhaust-gas radiator 48, and collecting the water in the water tank 22. This makes possible to reduce the amount of water vapor which becomes liquid in the pipes P8, P9, making it possible to further reduce the amount of water which is discharged from the discharge ports P9a.

The absorption member 86 is supplied with wind which is generated by the fan 34, and wind generated by the fan 50. This facilitates vaporization of the water absorbed in the absorption member 86, allowing more water to evaporate from the absorption member 86. Therefore, there is no need to provide a heater, etc., separately, and it is possible to dry the absorption member 86 and the holder unit 72 quickly, with a simple arrangement.

By disposing the absorption member 86 on a more downstream side of the airflow (downwind side) than the pipes P6 through P9, the aqueous solution radiator 32 and the exhaust-gas radiator 48, it becomes possible to supply the absorption member 86 with warm wind which has passed around an outer circumference of the pipes P6 through P9 (especially the pipe P6), of the aqueous solution radiator 32, or of the exhaust-gas radiator 48, making it possible to dry the absorption member 86 more quickly. Therefore, even if the amount of water contained in the exhaust gas has increased, it is still possible to facilitate evaporation of the water held in the absorption member 86, and to prevent the water from being rotten in the absorption member 86.

The output of the fan 50 changes depending on the amount of water in the water tank 22, but since there is another fan 34 which can supply wind to the absorption member 86, it is possible, even if the fan 50 has a small output, to dry the absorption member 86 and the holder unit 72 reliably.

It should be noted here that in the above-described preferred embodiment, description was made for a case where the pipe P9 is connected with the pipe P8. However, exhaust gas may be discharged from the discharge ports P8a (see FIG. 4) of the pipe P8.

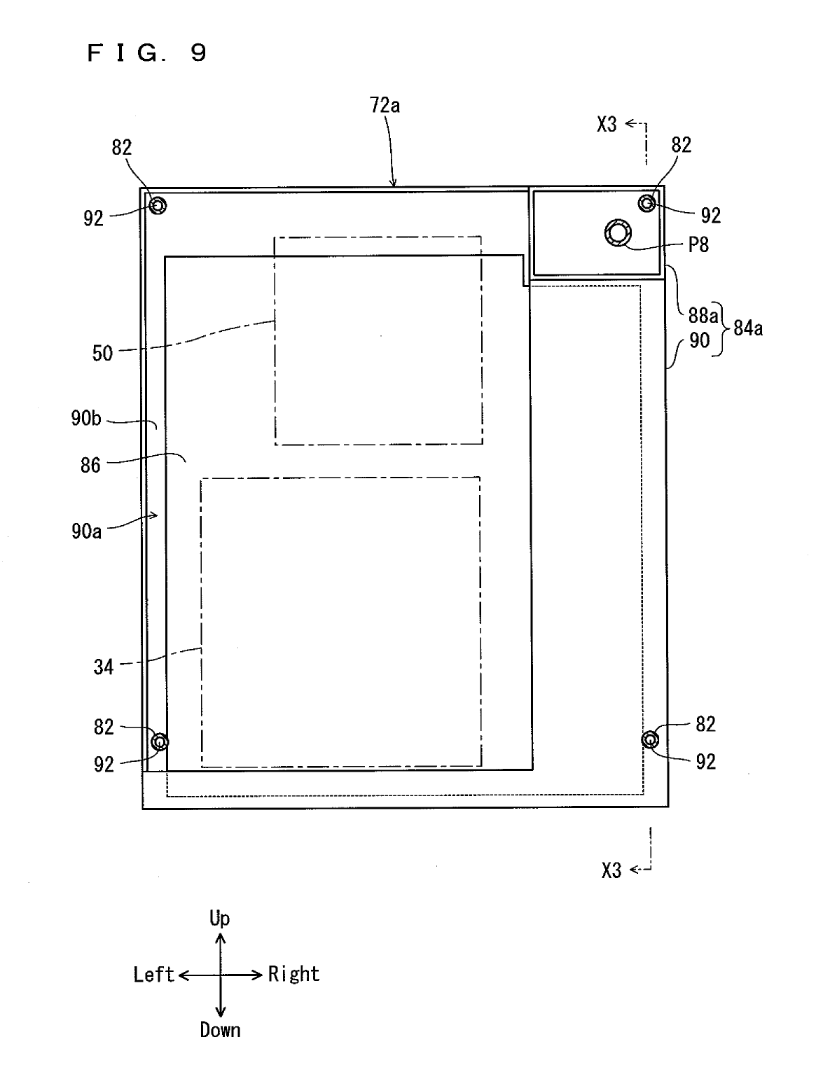

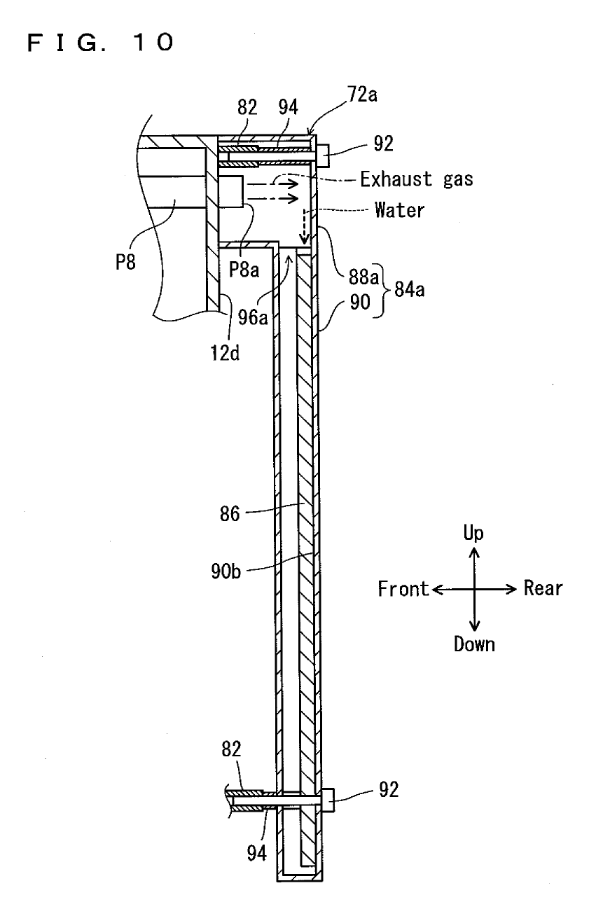

In this case, the holder unit 72 is replaced by a holder unit 72a as shown in FIG. 9 and FIG. 10. FIG. 9 is a sectional view of the fuel cell system 10 in FIG. 2, with the holder unit 72 replaced by the holder unit 72a. The section is made by cutting the system with the plane where the casing 12 and the holder unit 12a contact with each other, and the view is taken from a direction indicated by Arrow Z. FIG. 10 is a diagram which shows a section of the fuel cell system 10 in FIG. 9, taken in lines X3-X3. In the holder unit 72a, the housing member 84 in the holder unit 72 is replaced by a housing member 84a. The housing member 84a includes an enclosing portion 88a, but its left wall is not provided with the cutout 96 and instead, its bottom wall is formed with a communication port 96a which provides communication between the enclosing portion 88a and the housing portion 90 (see FIG. 10). Besides this, the housing members 84 and 84a are essentially the same.

As shown in FIG. 10, in this case, exhaust gas discharged from the discharge ports P8a blows a rear wall of the enclosing portion 88a. Water contained in the exhaust gas slides down on the rear wall, flows through the communication port 96a and reaches the absorption member 86 of the housing portion 90. The exhaust gas which has lost the water (liquid) flows through the communication port 96a, and into the housing portion 90, and then out of the system from the opening 90a. Therefore, it is possible, just as in the case where the pipe P9 is used, to easily and reliably prevent the surrounds from becoming wet.

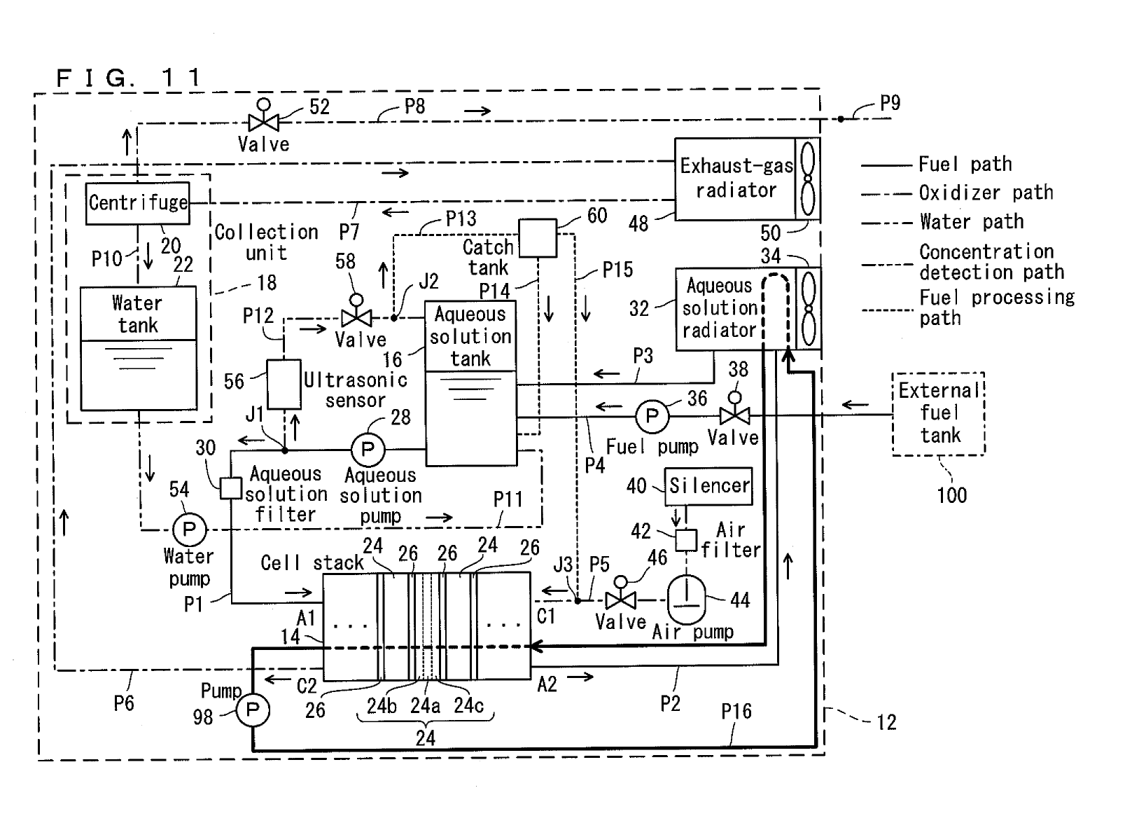

As shown in FIG. 11, there may be further provided a coolant pipe 16 which passes through the cell stack 14 and the aqueous solution radiator 32; and a pump 98 connected with the coolant pipe P16.

The coolant pipe P16 provides a closed path and contains a coolant for cooling the cell stack 14. When the pump 98 is driven, circulatory supply of the coolant is made to the cell stack 14. In other words, the coolant passes through the cell stack 14, then through the aqueous solution radiator 32, and then supplied again to the cell stack 14.

In this case, the coolant which is supplied to the cell stack 14 is warmed by heat which the coolant absorbs from the cell stack 14 as it cools the cell stack 14. The warmed coolant flows through the coolant pipe P16 toward the aqueous solution radiator 32. By driving the fan 34 in this process, it becomes possible to generate wind which will pass around an outer circumference of the coolant pipe P16 near the fan 34 and then be supplied to the absorption member 86. Since the wind is warm after passing around the circumference of the warm coolant pipe P16, the arrangement makes possible to vaporize more of the water which is held by the absorption member 86, making possible to prevent the water from being rotten while being held in the absorption member 86.

It should be noted here that in the above-described preferred embodiments, description was made for a case where the discharge ports P9a (P8a) and the holder unit 72 (72a) are provided outside of the casing 12. However, the discharge port and the holding unit may be provided inside the casing.

Also in the above-described preferred embodiments, description was made for a case where the absorption member 86 is disposed on a more downstream side of the gas flow (downwind side) than the aqueous solution radiator 32 and the exhaust-gas radiator 48 so that the absorption member 86 is supplied with warm wind. However, the present invention is not limited by this. For example, the blades of the fans 34, 50 may be rotated in the reverse direction so that the wind will come from the side closer to the absorption member 86, to the aqueous solution radiator 32 and to the exhaust-gas radiator 48. In other words, the fans 34, 50 may be driven in such a way that the absorption member 86 is on a more upstream side of the gas flow (upwind side) than the aqueous solution radiator 32 and the exhaust-gas radiator 48. With such an arrangement where the wind is supplied from the side closer to the absorption member 86 to the aqueous solution radiator 32 and the exhaust-gas radiator 48, the wind will flow on the surface of the absorption member 86, and it is possible to facilitate vaporization of the water from the absorption member 86.

Further, in the above-described preferred embodiments, description was made for a case where vaporization of water held by the absorption member 86 is facilitated by the fans 34, 50. However, the present invention is not limited by this. For example, a heater, etc., may be provided separately in order to facilitate vaporization of the water.

It should be noted here that in the above-described preferred embodiments, description was made for a case where the exhaust-gas radiator 48 is cooled by air, i.e. by the wind from the fan 50. However, the exhaust-gas radiator 48 may be cooled by liquid, using a coolant.

Also, the exhaust-gas radiator 48 may be connected directly with the cathode outlet C2 of the cell stack 14 without using the pipe P6.

In the above-described preferred embodiments, description was made for a case where the absorption member 86 is disposed in such a way that water contained in exhaust gas is supplied from above. However, the present invention is not limited by this. For example, water may be collected in a housing portion of a housing member, and then absorbed by an absorption member.

Further, in the above-described preferred embodiments, description was made for a case where the holder unit 72 (72a) including the absorption member 86 which absorbs water defines the holding unit. However, the present invention is not limited by this. For example, the holding unit may be provided by a container disposed near the discharge port of the discharge pipe so as to receive the exhaust gas from the discharge port.

It should be noted here that the positional relationship between the discharge pipe and the holding unit is not limited to the one disclosed in the preferred embodiments described thus far. For example, there may be provided a variable device arranged to vary the distance between the discharge ports of the discharge pipe and the holding unit, so that the distance from the discharge port to the holding unit will be changed in accordance with the ambient temperature.

Further, in the above-described preferred embodiments, description was made for a case where the fuel is provided by methanol, and the aqueous fuel solution is provided by aqueous methanol solution. However, the present invention is not limited by this. The fuel may be provided by other alcoholic fuel such as ethanol, and the aqueous fuel solution may be provided by other aqueous alcoholic solution such as aqueous ethanol solution.

Further, in the above-described preferred embodiments, description was made for a direct methanol fuel cell system. However, the present invention is not limited by this. The present invention is applicable also to fuel cell systems mounted with a reformer, and hydrogen fuel cell systems where fuel cells are supplied with hydrogen gas as fuel.

It should be noted here that the present invention is also applicable to fuel cell systems for use in transportation equipment such as motorbikes, electronic equipment such as personal computers, etc., as well as stationary (fixed-type) fuel cell systems.

The present invention being thus far described and illustrated in detail, it is noted that these description and drawings only represent examples of the present invention, and should not be interpreted as limiting the invention. The scope of the present invention is only limited by words used in the accompanied claims.

What is claimed is:

1. A fuel cell system comprising:
a fuel cell including a cathode;
a discharge pipe connected with the cathode and arranged to guide exhaust gas containing water and water vapor from the cathode to an outside; and
a holding unit arranged to hold the water after the water has been discharged from the discharge pipe.

2. The fuel cell system according to claim 1, wherein the holding unit includes an absorption member arranged to absorb the water.

3. The fuel cell system according to claim 1, further comprising a casing which accommodates the fuel cell, wherein the holding unit is provided outside of the casing.

4. The fuel cell system according to claim 1, further comprising a collection unit arranged in the discharge pipe to collect the water contained in the exhaust gas.

5. The fuel cell system according to claim 4, further comprising a liquefying unit provided between the cathode and the collection unit to liquefy the water vapor contained in the exhaust gas.

6. The fuel cell system according to claim 2, further comprising a wind supplying unit arranged to supply wind to the absorption member.

7. The fuel cell system according to claim 6, wherein the wind supplying unit is arranged to supply the absorption member with the wind which has been supplied to an outer circumference of the discharge pipe.

8. The fuel cell system according to claim 6, further comprising a liquefying unit arranged in the discharge pipe to liquefy the water vapor contained in the exhaust gas, wherein the wind supplying unit supplies the absorption member with the wind which has been supplied to an outer circumference of the liquefying unit.

9. The fuel cell system according to claim 6, wherein the fuel cell includes an anode, the fuel cell system further comprising a cooling unit arranged to cool aqueous fuel solution from the anode, the wind supplying unit arranged to supply the absorption member with the wind which has been supplied to an outer circumference of the cooling unit.

10. The fuel cell system according to claim 6, further comprising a coolant pipe for a coolant to flow after passing the fuel cell, wherein the wind supplying unit supplies the absorption member with the wind which has been supplied to an outer circumference of the coolant pipe.

11. The fuel cell system according to claim 2, wherein the absorption member is made of one of paper, cloth, sponge, porous ceramic, foam metal, a polymer, or combinations thereof.

12. The fuel cell system according to claim 2, wherein the absorption member is arranged to receive exhaust gas from discharge ports.

13. The fuel cell system according to claim 2, further comprising at least one fan, wherein the absorption member is arranged to receive wind blown by the at least one fan.

14. The fuel cell system according to claim 13, further comprising an aqueous solution radiator arranged to warm the wind blown by the at least one fan onto the absorption member.

15. The fuel cell system according to claim 1, wherein the holding unit includes a housing member and an absorption member.

16. The fuel cell system according to claim 4, wherein the collection unit includes a centrifuge and a water tank.

17. The fuel cell system according to claim 5, wherein the liquefying unit includes an exhaust-gas radiator.

18. The fuel cell system according to claim 6, wherein the wind supplying unit includes at least two fans arranged to supply the wind to the absorption member.

19. The fuel cell system according to claim 9, wherein the cooling unit includes an aqueous solution radiator.

20. Transportation equipment comprising the fuel cell system according to claim 1.
